(19) United States
(12) Patent Application Publication
(10) Pub. No.: US 2026/0096680 A1
(43) Pub. Date: Apr. 9, 2026

(54) APPARATUS FOR RITUAL PERFORMANCE

(71) Applicant: Jayendra DABHADE, Aldie, VA (US)

(72) Inventor: Jayendra DABHADE, Aldie, VA (US)

(21) Appl. No.: 19/348,601

(22) Filed: Oct. 2, 2025

Related U.S. Application Data
(60) Provisional application No. 63/703,624, filed on Oct. 4, 2024.

(51) Int. Cl. A47G 33/00; G05B 15/02; G06F 3/0488; G06F 3/16

(52) U.S. Cl. CPC A47G 33/008; G05B 15/02; G06F 3/0488; G06F 3/167

(57) ABSTRACT

The present invention relates to a portable autonomous electronic apparatus designed to assist users in performing various types of rituals. The apparatus includes a central processing unit (CPU) that coordinates various subsystems, including a display system for providing visual outputs, a user input interface for controlling the apparatus, and an audio system for delivering ritual instructions and related sounds. The apparatus may also feature a networking module for receiving updates and enabling remote control, and an automated electromechanical ritual execution system for physically performing rituals such as bathing and scenting of sacred objects. The system may be customizable, supporting multiple languages and regional variations. The system may include a backup battery to ensure uninterrupted operation when external power is unavailable.

### RELATED APPLICATIONS

This application claims the benefit of priority of U.S. Provisional Patent Application No. 63/703,624 entitled “Apparatus for Ritual Performance” filed Oct. 4, 2024, the entire contents of which are incorporated herein by reference for all purposes.

### BACKGROUND

Various customs and populations practice diverse varieties of rituals and religious practices, some of which involve ritual treatment to objects, such as sacred objects, idols, and other special objects. Some rituals include a series of steps that are performed on the objects, such as bathing or washing, anointing, illuminating, making offerings, and reciting chants or prayers. Traditionally, many such rituals are performed with the assistance of trained individuals (e.g., priests) who ensure that the rituals are conducted correctly. However, the fast pace of modern life has made it increasingly difficult for individuals to adhere to these practices regularly, particularly without the presence of a priest.

### SUMMARY

Various aspects provide a solution to the challenges of performing traditional rituals in modern times by offering a portable, autonomous electronic apparatus that automates and guides the user through such rituals. In various aspects, the apparatus may be equipped with a central processing unit, display subsystem, user input interface, audio subsystem, networking module, and an automated electromechanical ritual execution subsystem. These components work together to ensure that correct actions are performed and prayers are recited during each step of a ritual so that the rituals are performed correctly, all with interactions by users.

Various aspects allow for the bathing and scenting of ritual items, playing of corresponding music and/or prayers, and the provision of explanations for various rituals. Various aspects support customization for different regions, sects, and language preferences, and can be updated regularly through its networking module. The user-friendly design ensures accessibility for all users, including those with disabilities, and provides a backup battery subsystem to power the apparatus even during power outages.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a perspective view of the portable electronic apparatus showing the main components, including the display subsystem, user input interface, audio subsystem, and the automated electromechanical ritual execution system.

FIG. 2 is a schematic diagram of the central processing unit and its connection to other subsystems such as the display subsystem, user input interface, audio subsystem, networking module, and automated electromechanical ritual execution subsystem.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

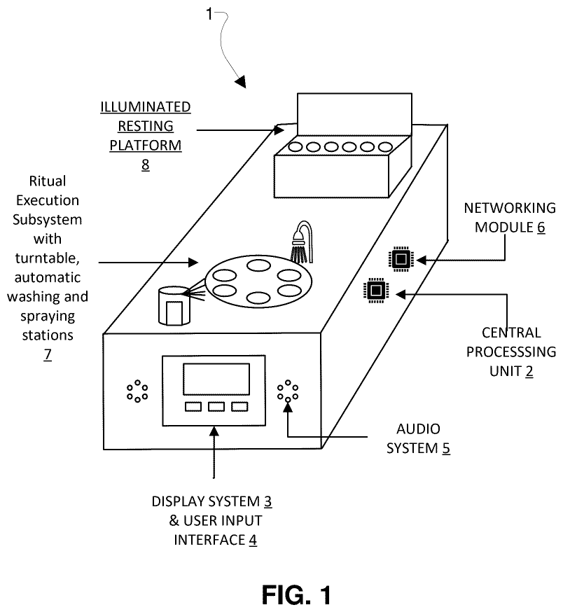

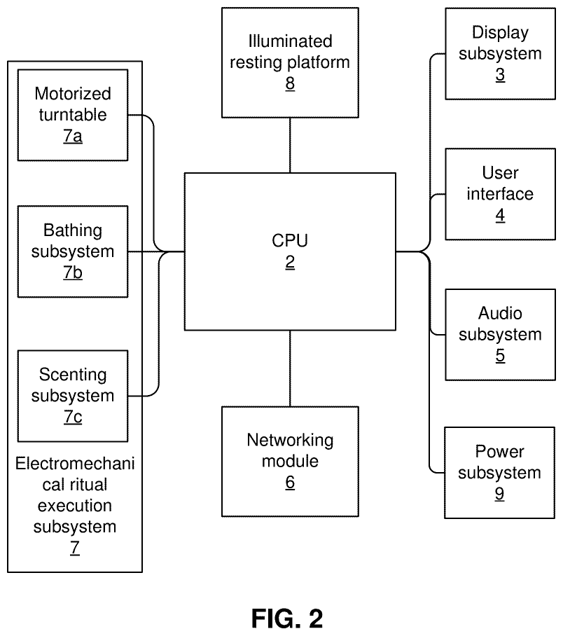

The present disclosure relates to a portable autonomous electronic apparatus designed to assist users in performing traditional worship rituals across many religions. Referring to FIGS. 1 and 2, the portable autonomous electronic apparatus 1 includes several key components that work together to facilitate the accurate and efficient execution of these rituals. The main components of the apparatus may include a central processing unit (CPU) 2, a display subsystem 3, a user input interface 4, an audio subsystem 5, a networking module 6, an automated electromechanical ritual execution subsystem 7, an illuminated resting platform 8 for supporting and illuminating sacred objects, and an integrated power subsystem 9. Each of these components and subsystems is integrated into the portable electronic apparatus 1 within a housing that is sturdy and user-friendly, allowing for easy transport and use in various settings. The apparatus is versatile, accommodating sacred objects of varying shapes and sizes, and can be configured for different types of worship practices.

FIG. 1 depicts the portable electronic apparatus 1, which serves as the housing and provides electronic interfaces for all components and subsystems. The apparatus is designed to be sturdy, ensuring that the sacred space integrity is maintained at all times. Examples of suitable materials for the housing include high strength metal alloys such as industrial grade stainless steel, which provide durability while maintaining a robust structure.

The apparatus may be equipped with a lithium-ion battery as a primary power source, along with a backup battery subsystem to ensure uninterrupted operation during worship rituals.

The central processing unit (CPU) 2 is the core of the apparatus's operation and is electronically coupled to each of the major components and subsystems as illustrated in FIG. 2. It manages and coordinates all activities within the apparatus, executing software algorithms that control the sequence of worship rituals. Examples of suitable CPUs include multi-core processors such as ARM Cortex-A series, which provide sufficient computational power for multitasking and managing the apparatus's various functions.

The CPU 2 is responsible for integrating user inputs from the interface, processing data from the networking module, and synchronizing the operation of the automated electromechanical ritual execution subsystem 7. Additionally, the CPU 2 could include an integrated micro-controller like an STM32 for handling real-time control of the electromechanical subsystems.

The display subsystem 3, illustrated in FIG. 1, may be a touch-sensitive screen that serves as the primary user interface for interacting with the apparatus. Examples of suitable display technologies include LCD (Liquid Crystal Display) and OLED (Organic Light Emitting Diode) screens, which offer high-resolution and vibrant color output. The display subsystem may also include an anti-glare coating or an adjustable brightness feature to ensure visibility in various lighting conditions.

The display subsystem allows users to navigate through the various functions of the apparatus, select prayers and rituals, and customize their worship experience. The display subsystem 3 also provides a visual output of the prayers being recited, enabling users to follow along and chant as needed. Additionally, it displays multimedia content, including text, graphics, and videos, to explain the significance of the rituals being performed.

The user input interface 4, as shown in FIG. 1, is an essential component that allows users to control the apparatus. This interface may be touch-based, providing an intuitive and user-friendly interface experience. Examples of touch-based interfaces include capacitive touchscreens, which are widely used in smartphones and tablets for their responsiveness and durability.

In addition to touch inputs, the interface may include voice recognition technology, such as a built-in microphone array, to allow users to control the apparatus with voice commands as an alternative input method. Users can activate specific rituals, adjust settings, and select prayers using the user input interface 4. The user input interface 4 is designed to accommodate users of all ages and abilities, including those with disabilities, by supporting alternative input methods such as voice commands.

The audio subsystem 5, depicted in FIG. 1, is responsible for delivering high-quality sound for prayers and ritual instructions. Examples of suitable audio components include high-fidelity speakers, such as those used in premium portable devices, which can produce clear and precise sound output. The audio subsystem may also include noise-cancellation technology to enhance sound clarity in noisy environments. Additionally, the subsystem could integrate a digital signal processor (DSP) to manage audio output and provide features such as equalization, bass enhancement, and multi-language support.

The audio output is customizable, allowing users to adjust the volume and select the language or dialect of the prayers. The audio subsystem 5 works in conjunction with the display subsystem 3 to provide a fully immersive worship experience, guiding the user through each step of the ritual with corresponding prayers and explanations.

A networking module 6, shown in FIG. 1, enables the apparatus to connect to external networks for regular updates and communication with religious organizations. Examples of networking technologies include Wi-Fi modules (such as those based on IEEE 802.11 standards) and Bluetooth Low Energy (BLE) for wireless connectivity. The networking module may also include an Ethernet port for wired connections, providing reliable communication in environments with unstable wireless signals.

This module 6 ensures that the apparatus remains current by receiving updated prayers and rituals. It also allows for remote control during special religious events, where the apparatus can perform specific rituals as directed by external commands. The networking module 6 may support wired, wireless, or both wired and wireless connectivity, providing flexibility in different environments.

The automated electromechanical ritual execution subsystem 7, illustrated in FIG. 1, includes a motorized turntable platform 7a that positions the sacred objects for bathing and scenting. Examples of suitable motors include stepper motors or servomotors, which offer precise control over the platform's movement.

The automated electromechanical ritual execution subsystem 7 further includes a sacred object bathing subsystem 7b that uses a pump-driven mechanism to deliver bathing liquid onto the sacred objects. Suitable pumps could include peristaltic pumps or diaphragm pumps, known for their reliability and accuracy in fluid delivery.

The automated electromechanical ritual execution subsystem 7c further includes a sacred object scenting subsystem that sprays scented liquid from the side, which can be achieved using a small solenoid valve combined with a pressurized air subsystem to ensure even distribution of the scent.

The apparatus 1 may further include an illuminated resting platform 8 for supporting sacred objects (e.g., idols) before, during, and/or after rituals. This platform may include lighting elements (e.g., LED, fluorescent, or incandescent lights) positioned and oriented to illuminate objects on the platform.

The apparatus 1 includes an integrated power supply 9, which may be configured to receive power from an external source (e.g., alternating current (AC) from a utility power source or generator, a solar array, an external battery, etc.), and condition the voltage and current supplied to the CPU, components, and subsystems of the apparatus.

As illustrated in FIG. 2, the CPU 2 is connected to each of the components and subsystems of the apparatus via control connections, such as on/off control signals, data cables, internal networks, etc. The CPU 2 is programmed with processor-executable software instructions to send control signals to each of the components and subsystems of the apparatus so as to execute the entire ritual process, including actuating individual subsystems to perform their function at the appropriate time in the ritual. Through pre-programming of the CPU 2, the CPU2 is able to sequence and synchronize multiple ritual operations to ensure that a ritual is performed accurately and in the correct sequence.

The following paragraphs provide examples of some embodiments.

Example 1. An apparatus for performing rituals involving certain objects, including: a portable housing; a central processing unit (CPU) within the housing; an internal memory coupled to the CPU; a display subsystem coupled to the CPU and configured to display text and images; a user input interface coupled to the CPU consisting of a touch-based input method, such as a capacitive touchscreen, and optionally a voice command system for controlling the apparatus and selecting various prayers and rituals; an audio subsystem coupled to the CPU and including high-fidelity speakers and a digital signal processor (DSP); an automated electromechanical ritual execution subsystem including: a motorized platform driven by a motor to position objects for ritual activities; a bathing subsystem including a fluid delivery pump controlled by the CPU and fluidically coupled to a container for holding a bathing liquid, and a dispensing head positioned to dispense the bathing liquid on objects positioned on the motorized platform; a scenting subsystem configured to spray scented liquid on objects positioned on the motorized platform; and a power subsystem configured to power the CPU and other components and subsystems of the apparatus, in which the CPU is electronically coupled to the components and subsystems of the apparatus and programmed with software to control operations of the apparatus components and subsystems through each step of preprogrammed rituals.

Example 2. The apparatus of example 1, further including an expandable memory coupled to the CPU.

Example 3. The apparatus of any of examples 1-2, in which the display system includes a touch-sensitive screen that is capable of adjusting for different lighting conditions.

Example 4. The apparatus of any of examples 1-3, further including a networking module coupled to the CPU and configured to connect to external networks via one or more of Wi-Fi, Bluetooth, or Ethernet to receive updates of ritual processes and content.

Example 5. The apparatus of any of examples 1-4, in which the user input interface coupled to the CPU includes a touch-based input interface configured to receive user inputs to the CPU for controlling the apparatus and selecting rituals.

Example 6. The apparatus of any of examples 1-5, in which the user input interface coupled to the CPU includes a voice command system configured to receive user voice commands and provide corresponding inputs to the CPU for controlling the apparatus and selecting rituals.

Example 7. The apparatus of any of examples 1-6, in which the power system includes a backup battery power system configured to power the CPU and other components of the apparatus when there is no access to external power sources.

Example 8. The apparatus of any of examples 1-7, in which the apparatus includes a feedback mechanism, enabling users to provide input on their experience with the apparatus, customize settings, and adjust rituals and prayers as needed.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. An apparatus for performing rituals involving certain objects, comprising:
a portable housing;
a central processing unit (CPU) within the housing;
an internal memory coupled to the CPU;
a display subsystem coupled to the CPU and configured to display text and images;
a user input interface coupled to the CPU consisting of a touch-based input method, such as a capacitive touchscreen, and optionally a voice command system for controlling the apparatus and selecting various prayers and rituals;
an audio subsystem coupled to the CPU and comprising high-fidelity speakers and a digital signal processor (DSP);
an automated electromechanical ritual execution subsystem comprising:
a motorized platform driven by a motor to position objects for ritual activities;
a bathing subsystem comprising a fluid delivery pump controlled by the CPU and fluidically coupled to a container for holding a bathing liquid, and a dispensing head positioned to dispense the bathing liquid on objects positioned on the motorized platform;
a scenting subsystem configured to spray scented liquid on objects positioned on the motorized platform; and
a power subsystem configured to power the CPU and other components and subsystems of the apparatus,
wherein the CPU is electronically coupled to the components and subsystems of the apparatus and programmed with software to control operations of the apparatus components and subsystems through each step of preprogrammed rituals.

2. The apparatus of claim 1, further comprising an expandable memory coupled to the CPU.

3. The apparatus of claim 1, wherein the display system includes a touch-sensitive screen that is capable of adjusting for different lighting conditions.

4. The apparatus of claim 1, further comprising a networking module coupled to the CPU and configured to connect to external networks via one or more of Wi-Fi, Bluetooth, or Ethernet to receive updates of ritual processes and content.

5. The apparatus of claim 1, wherein the user input interface coupled to the CPU comprises a touch-based input interface configured to receive user inputs to the CPU for controlling the apparatus and selecting rituals.

6. The apparatus of claim 1, wherein the user input interface coupled to the CPU comprises a voice command system configured to receive user voice commands and provide corresponding inputs to the CPU for controlling the apparatus and selecting rituals.

7. The apparatus of claim 1, wherein the power system includes a backup battery power system configured to power the CPU and other components of the apparatus when there is no access to external power sources.

8. The apparatus of claim 1, wherein the apparatus includes a feedback mechanism, enabling users to provide input on their experience with the apparatus, customize settings, and adjust rituals and prayers as needed.
